(19) United States
(12) Patent Application Publication
(10) Pub. No.: US 2009/0167653 A1
(43) Pub. Date: Jul. 2, 2009

(54) LIQUID CRYSTAL DISPLAY AND CONTROL METHOD THEREOF

(75) Inventor: CING-SHIN LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/061,910

(22) Filed: Apr. 3, 2008

(30) Foreign Application Priority Data
Dec. 27, 2007 (CN) 200710203480.1

(51) Int. Cl. G09G 3/36

(52) U.S. Cl. 345/87

(57) ABSTRACT

A liquid crystal display (LCD) includes an LCD panel, an orienting base, an imaging unit, an image processing unit, and a control unit. The LCD panel is configured for displaying information readable from any vantage point inside the viewing cone thereof. The orienting base is configured for supporting and orienting the LCD panel. The imaging unit is configured for capturing an image of an immediate area in front of the LCD panel. The image processing unit is configured for processing the captured images to detect whether the eyes of the viewer are within the immediate area but are outside the viewing cone of the LCD panel, and, if yes, to locate the eyes of the viewer. The control unit is configured for controlling the orienting base to orient the LCD panel to aim the viewing cone of the LCD panel to include the located eyes of the viewer.

### BACKGROUND

1. Technical Field

The invention relates to liquid crystal displays (LCDs) and, more particularly, to an LCD and a control method thereof.

2. Description of Related Art

Generally, liquid crystal displays (LCDs) are only readable from a vantage point within a limited viewing cone. When the LCD is viewed from outside of the viewing cone, any images on the LCD will seem garbled, poorly saturated, of poor contrast, blurry or too faint, resulting in the need to manually adjust orientation of the LCD. This is inconvenient.

Therefore, it is desirable to provide an LCD and a control method thereof, which can overcome the above-mentioned problem.

### SUMMARY

In an exemplary embodiment, a liquid crystal display (LCD) includes an LCD panel, an orienting base, an imaging unit, an image processing unit, and a control unit. The LCD panel is configured for displaying information readable from any vantage point inside the viewing cone thereof. The orienting base is configured for supporting and orienting the LCD panel. The imaging unit is configured for capturing an image of an immediate area in front of the LCD panel. The image processing unit is configured for processing the captured images to detect whether the eyes of the viewer are within the immediate area but are outside the viewing cone of the LCD panel, and, if yes, to locate the eyes of the viewer. The control unit is configured for controlling the orienting base to orient the LCD panel to aim the viewing cone of the LCD panel to include the located eyes of the viewer.

### BRIEF DESCRIPTION OF THE DRAWINGS

Many aspects of the present liquid crystal display (LCD) and control method should be better understood with reference to the following drawings. The components in the drawings are not necessarily drawn to scale, the emphasis instead being placed upon clearly illustrating the principles of the present LCD and control method. Moreover, in the drawings, like reference numerals designate corresponding parts throughout the several views.

FIG. 1 is a schematic view of an LCD, according to an exemplary embodiment.

FIG. 2 is a functional diagram of the LCD of FIG. 1.

FIG. 3 is a flow chart of a control method for an LCD, according to an exemplary embodiment.

### DETAILED DESCRIPTION OF THE EMBODIMENTS

Embodiments of the present liquid crystal display (LCD) and control method will now be described in detail with reference to the drawings.

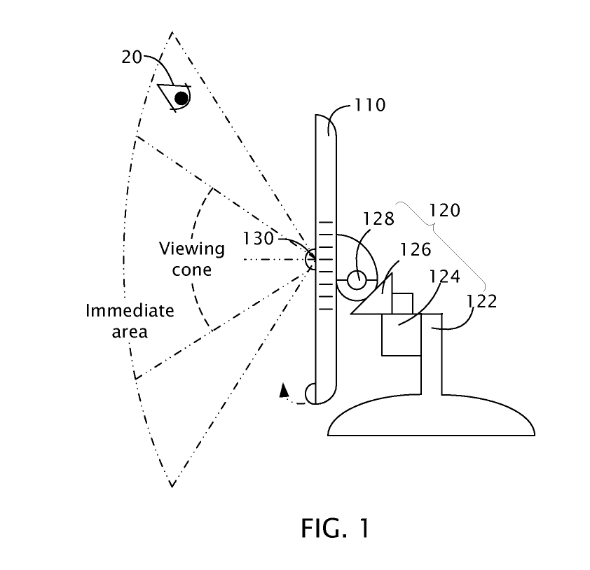

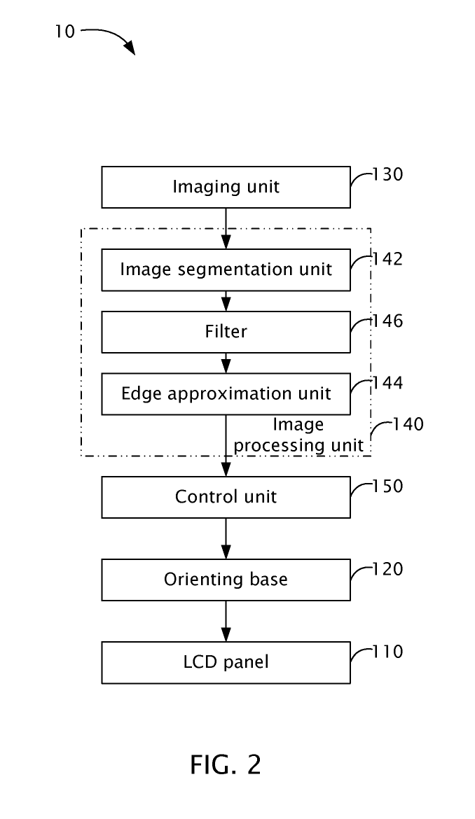

Referring to FIGS. 1, 2, an LCD 10, according to an exemplary embodiment, includes an LCD panel 110, an orienting base 120, an imaging unit 130, an image processing unit 140, and a control unit 150. The LCD panel 110 is configured for displaying information readable from any vantage point inside the viewing cone thereof. The orienting base 120 is configured for supporting and orienting the LCD panel 110. The imaging unit 130 is configured for capturing an image of an immediate area in front of the LCD panel 110. The image processing unit 140 is configured to process the captured image to find out whether the eyes 20 of a viewer are within the immediate area but are outside the viewing cone of the LCD panel 110, and, if yes, to locate the eyes 20 of the viewer and instruct the control unit 150 to reorient the LCD panel 110 by repositioning the orienting base 120, thereby adjusting the aim of the viewing cone to include the located eyes 20 of the viewer.

The imaging unit 130, the image processing unit 140, the control unit 150, and the orienting base 120 work in a continuous manner. Thereby, the LCD 10 is capable of continually adjusting the aim of the viewing cone of the LCD panel 110 to include the eyes 20 of the viewer.

In this embodiment, the orienting base 120 includes a main body 122, a first motor 124, a connector 126, and a second motor 128. The first motor 124 is supported by the main body 122, and is configured for driving the LCD panel 110 to rotate about a first axis. The connector 126 is configured for connecting the first and second motors 124, 128. The second motor 128 is fixed to the LCD panel 110, and is configured for driving the LCD panel 110 to rotate about a second axis which is perpendicular to the first axis.

It should be understood that the orienting base 120 is not limited by this embodiment, but can conform to other arrangements that can provide the above described support and orientation functions.

The imaging unit 130 includes a video camera mounted on an edge of the LCD panel 110 and oriented to capture images of the immediate area in front of the LCD panel 110. Understandably, the number of video cameras is not limited to one, and can be determined by the manufacturer or the user depending on the desired detection accuracy.

The image processing unit 140 includes an image segmentation unit 142, and an edge approximation unit 144. The image segmentation unit 142 is configured for segmenting the captured consecutive images to check whether the area of a current captured image corresponding to the viewing cone encompasses the eyes 20 of a viewer, and, if yes, make no adjustment and check again, if no, check the area of the current captured image corresponding to outside the perimeter of the viewing cone. If the eyes 20 are found outside the perimeter of the viewing cone but inside the immediate area, detect edges of the eyes 20 of the viewer in the image. The edge approximation unit 144 is configured to perform edge approximation on the image containing the eyes 20 to obtain new position coordinates for the LCD panel 110 corresponding to shifting the aim of the viewing cone to be generally centered about the eyes 20 as located in the image. The image processing unit 140 further includes a filter 146 such as mean filter. This filter 146 is configured to filter the image containing the eyes 20 to reduce effects of noise during performance of edge approximation.

The image processing unit 140 and the control unit 150 can be can be integrated into a single control unit. Alternatively, such components can instead be software instructions written via a variety of software languages, including C, C++, Java, Visual Basic, and many others, and can be executed by hardware, such as an FPGA or an ASIC, to acquire the above-mentioned functionality of the components.

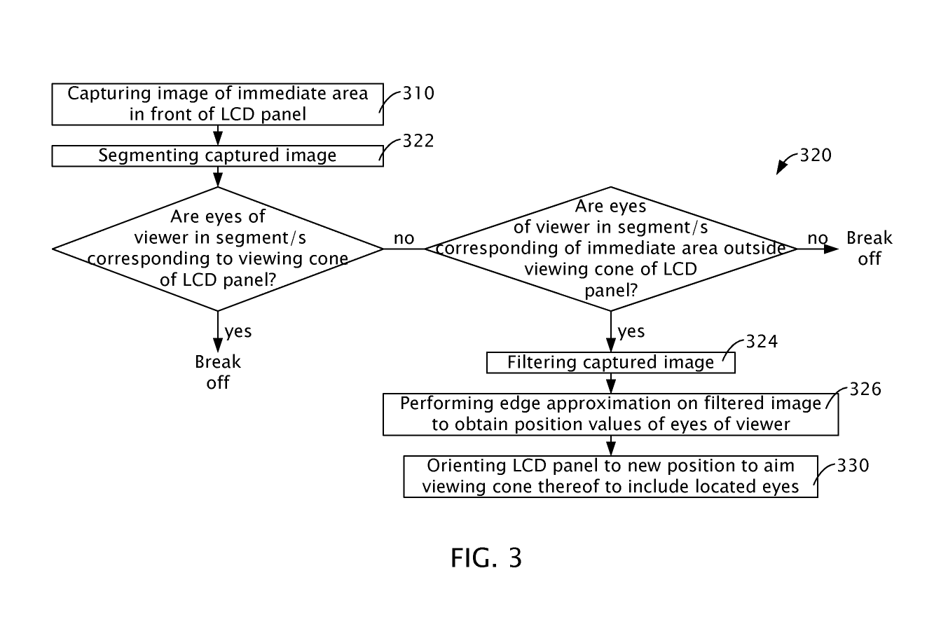

Referring to FIG. 3, a control method for controlling, for example, the LCD 10, includes the operations 310˜330.

Operation 310: capturing an image corresponding to the immediate area in front of the LCD panel 110. This is carried out by the imaging unit 130. In detail, when the LCD 10 is powered on, the imaging unit 130 starts to continuously capture images, one after another, of the immediate area in front of the LCD panel 110, and to continuously transmit the captured images to the image processing unit 140.

Operation 320: processing the current captured image to detect whether the eyes 20 of a viewer are inside the viewing cone according to its current orientation; if yes, break off, if no, check for the eyes 20 of the viewer in the area of the current captured image corresponding to outside the perimeter of the viewing cone but still within the immediate area; if no, break off, if yes, obtain new position coordinates for the LCD panel 110 corresponding to shifting the aim of the viewing cone to be generally centered about the eyes 20 as located in the image. This is carried out by the image processing unit 140 and by the following sub-operations 322˜326 (see FIG. 3). Sub-operation 322: segmenting the current captured image to check if the eyes 20 of the viewer are in the segment/s corresponding to the viewing cone; if yes, break off, if no, check the segment/s corresponding to the immediate area outside the viewing cone for the eyes 20 of the viewer; if no, break off, if yes, detect edges of the eyes 20 of the viewer. This is carried out by the image segmentation unit 142 and various techniques such as thresholding (including fixed threshold, isodata algorithm, background-symmetry algorithm, and triangle algorithm based), or edge finding (including a Gradient-based procedure using the Sobel, Roberts, or Prewitt operator), can be used in this sub-operation. Sub-operation 324: filtering the current captured image containing the eyes 20 of the viewer to reduce the effects of noise. This is carried out by the filter 146. Sub-operation 326: performing an edge approximation on the filtered image that contains the eyes 20 of the viewer to obtain position values of the eyes 20 of the viewer. This is carried out by the edge approximation unit 144.

Operation 330: orienting the LCD panel 110 to a new position to aim the viewing cone to include the located eyes 20 of the viewer. This is carried out by the control unit 150 and the orienting base 120. In detail, the control unit 150 receives the new position coordinates for the LCD panel 110 and sends driving signals generated according to the received new position coordinates to the orienting base 120.

The LCD 10 and control method together are capable of automatically self-orientating to advantageously maintain viewing quality for a user.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A liquid crystal display, comprising:
a panel for displaying information readable from any vantage point inside the viewing cone thereof;
an orienting base for supporting and orienting the panel;
an imaging unit for capturing an image of an immediate area in front of the panel;
an image processing unit for processing the captured image to detect whether eyes of a viewer are within the immediate area but are outside the viewing cone of the panel, and, if yes, to locate the eyes of the viewer; and
a control unit for controlling the orienting base to orient the panel to adjust the aim of the viewing cone of the panel to include the located eyes.

2. The liquid crystal display as claimed in claim 1, wherein the imaging unit, the image processing unit, the control unit, and the orienting base are configured to work continuously.

3. The liquid crystal display as claimed in claim 1, wherein the orienting base comprises:
a main body;
a first motor fixed to the main body and configured for driving the panel to rotate about a first axis;
a connector; and
a second motor connected to the first motor via the connector, the second motor being fixed to the panel, and configured for driving the panel to rotate about a second axis which is perpendicular to the first axis.

4. The liquid crystal display as claimed in claim 1, wherein the imaging unit comprises a video camera oriented to capture a plurality of consecutive images of the immediate area in front of the panel.

5. The liquid crystal display as claimed in claim 4, wherein the video camera is mounted on an edge of the panel.

6. The liquid crystal display as claimed in claim 1, wherein the image processing unit comprises:
an image segmentation unit for segmenting the captured image so as to find out whether the eyes of a viewer are within the immediate area but are outside the viewing cone of the panel, and, if yes, to detect edges of the eyes of the viewer; and
an edge approximation unit for performing an edge approximation on the found image containing the eyes of the viewer to obtain a plurality of position values for the eyes of the viewer, thereby locating the eyes of the viewer.

7. The liquid crystal display as claimed in claim 7, wherein the image processing unit comprises a filter for filtering the found image containing the eyes of the viewer so as to reduce the effect of noise therein before the edge approximation is performed.

8. A control method of a liquid crystal display, the liquid crystal display including a panel and an orienting base, the panel configured for displaying information readable from any vantage point inside the viewing cone thereof, the orienting base configured for supporting and orienting the panel, comprising:
capturing an image of an immediate area in front of the panel;
processing the captured images to detect whether eyes of a viewer are within the immediate area but are outside the viewing cone of the panel, and, if yes, to locate the eyes of the viewer; and
orienting the panel to adjust the aim of the viewing cone of the panel to include the located eyes of the viewer.

9. The control method as claimed in claim 8, wherein processing a captured image comprises:
segmenting the captured image to check whether the eyes of the viewer are in a segment corresponding to the viewing cone of the panel; if yes, breaking off, if no, checking whether the eyes of the viewer are in a segment corresponding to the immediate area outside the viewing cone; if no, breaking off, if yes, detecting edges of the eyes of the viewer; and
performing an edge approximation on the captured image to obtain a plurality of position values of the eyes of the viewer if the eyes of the viewer are in a segment corresponding to the immediate area outside the viewing cone.

10. The control method as claimed in claim 9, wherein segmenting the captured image is performed using a thresholding technique.

11. The control method as claimed in claim 10, wherein the thresholding technique is fixed threshold, isodata algorithm, background-symmetry algorithm, or triangle algorithm based.

12. The control method as claimed in claim 9, wherein segmenting the captured image is performed using an edge finding technique.

13. The control method as claimed in claim 12, wherein the edge finding technique uses the Sobel, Roberts, or Prewitt operator.

14. The control method as claimed in claim 9, wherein processing a captured image comprising:
filtering the captured image before the edge approximation is performed, if the eyes of the viewer are in a segment corresponding to the immediate area outside the viewing cone.
